(19) United States
(12) Patent Application Publication
(10) Pub. No.: US 2001/0053492 A1
(43) Pub. Date: Dec. 20, 2001

(54) TONER FOR DEVELOPING STATIC IMAGE, PROCESS FOR PRODUCING THE SAME, DEVELOPER FOR STATIC IMAGE, AND IMAGE FORMING METHOD

(76) Inventors: MASAAKI SUWABE, MINAMIASHIGARA-SHI (JP); SHUJI SATO, MINAMIASHIGARA-SHI (JP); YASUO KADOKURA, MINAMIASHIGARA-SHI (JP); HISAE YOSHIZAWA, MINAMIASHIGARA-SHI (JP); HIDEO MAEHATA, MINAMIASHIGARA-SHI (JP)

Correspondence Address: OLIFF & BERRIDGE PLC, P.O. BOX 19928, ALEXANDRIA, VA, 22320, US

(21) Appl. No.: 09/515,506

(22) Filed: Feb. 29, 2000

(30) Foreign Application Priority Data
Mar. 15, 1999 (JP) 11-067666

(51) Int. Cl. G03G 9/08

(52) U.S. Cl. 430/110.3; 430/110.4; 430/111.4; 430/137.14

(57) ABSTRACT

A toner for developing a static image having excellent charging characteristics and transferring characteristics, a process for producing the toner, a developer for a static image using the toner, and a process for producing an image are provided. A toner for developing a static image including at least a binder resin and a coloring agent, having an external additive adhered on a surface thereof, the toner having an average volume particle diameter D₅₀ of about from 3.0 to 8.0 μm, an average volume particle diameter distribution index GSDv of about 1.26 or less, and a surface property index expressed by the following equations of about 6.0 or less:

(surface property index)=(measured specific surface area)/(calculated specific surface area)

(calculated specific surface area)=6Σ(n×R²)/(ρ×Σ(n×R³))

wherein n represents a number of particles in a channel of a Coulter counter; R represents a channel particle diameter of a Coulter counter; and ρ represents a toner density, provided that measurement of the specific surface area is conducted by an adsorption method.

### FIELD OF THE INVENTION

The present invention relates to a toner for developing a static image used for developing a static latent image by an electrophotographic process and a electrostatic recording process, a process for producing the toner, a developer for a static image, and an image forming method.

### BACKGROUND OF THE INVENTION

A process of visualizing image information through a static latent image by an electrophotographic process is utilized in various fields. In the process, a static latent image is formed on a photoreceptor by a charging and exposing step of the electrophotographic process, and the static latent image is developed with a developer containing a toner and then visualized through transferring and fixing. The developer used herein includes a two-component developer including a toner and a carrier, and a one-component developer using solely a magnetic toner or a non-magnetic toner. The toner is generally produced by a kneading and pulverizing method, in which a thermoplastic resin is melted and kneaded with a pigment, a charge controlling agent and a releasing agent such as a wax, and after cooling, the mixture is finely pulverized and classified. In order to improve the flowability and the cleaning property of the toner, it is sometimes used after adding inorganic fine particles or organic fine particles to the surface of the toner particles.

According to the progress of the information-oriented society in recent years, there is a demand of providing an information document produced by various process as an image of good image quality, and studies for improving the image quality in various processes for producing an image. This trend is also applied in the process for forming an image by using the electrophotographic process, and particularly in the electrophotographic process, a toner having a small particle size and a sharp particle size distribution is demanded for realizing an image of high resolution.

For example, in a digital full-color duplicator or printer, a color original image is subjected to color separation with filters of B (blue), R (red) and G (green), and a static latent image of a dot diameter of from 20 to 70 μm corresponding to the original image is developed by subtractive synthesis of color using developers of Y (yellow), M (magenta), C (cyan) and Bk (black). In this process, a larger amount of the toner must be transferred in comparison to the related art monochrome type machine, and the toner must be applied to dots of a smaller diameter. Therefore, the toner is demanded to have charging uniformity including environmental dependency, uniformity in charge maintenance property, sharpness of particle size distribution, and maintenance of strength of the toner. A low temperature fixing property is further demanded in view of the high-speed operation and the energy saving of the duplicator and the printer. In view of the factors described in the foregoing, a toner having a sharp particle size distribution and a small particle size is demanded.

However, the smallest particle size that can be realized by the pulverizing and classifying in the related art kneading and pulverizing method is about 8 μm under the conditions of economy and performance. Studies have been conducted to produce a toner having a small particle size in various pulverizing methods, but in the method of decreasing the particle size in the kneading and pulverizing method, the particle size is decreased but the particle size distribution is not improved. As a result, there arises a problem in that the toner component having a fine particle size contaminates the carrier and the photoreceptor, and the toner is scattered, and therefore both the high image quality and the high reliability cannot be realized at the same time.

Under the circumstances, processes for producing a toner by various polymerization methods, which are different from the kneading and pulverizing method, are studied, for example, a process for producing a toner by a suspension polymerization method (JP-Laid open No. S60-57954) and a process for producing a toner by a dispersion polymerization method (JP-Laid open No. S62-073276 and JP-Laid open No. H5-027476).

However, in the suspension polymerization method and the dispersion polymerization method, even though the particle size distribution of the toner can be improved in a certain extent, there is a room for improvement, and the classification must be conducted in most cases.

In order to solve the problems, a process for producing a toner by an emulsion polymerization and aggregation method is recently proposed (JP-Laid open No. H6-250439). In this process, a dispersion of resin fine particles is produced by a polymerization method, such as emulsion polymerization, and a colorant dispersion is separately produced by dispersing a colorant in a solvent. After mixing the dispersions, an aggregation agent is added thereto to conduct aggregation until the resin fine particles and the colorant have the prescribed particle diameters, and the aggregated particles are stabilized at the prescribed particle diameters. Thereafter, the resin particles are fused by heating to a temperature higher than the glass transition point of the resin particles to produce a toner.

The toner particles produced by the emulsion polymerization and aggregation method exhibit excellent characteristics in the particle size distribution in comparison to the toner particles produced by the other polymerization methods represented by the related art suspension polymerization method, and thus provide an image of high quality.

In the production process of a toner by the emulsion polymerization and aggregation method, because the aggregated particles are fused by heating at a temperature higher than the glass transition point of the resin fine particles, it is possible to produce a toner having various shapes and surface conditions, such as from a toner having an irregular particle shape having a large number of unevenness on the surface thereof to a toner having a spherical particle shape having a smooth surface.

A specific surface area is one method for evaluating the surface property of the toner. However, the specific surface area has a dependency on the particle size, and a measured value itself cannot be used for evaluation of the specific toners. It has been proposed that in order to provide an index showing the surface property of a toner, a calculated value of the specific surface area is obtained based on the average particle size of the toner, and a ratio to the measured value of the specific surface area is obtained (JP-Laid open No. S59-58438) This method can express the extent how much the surface property of the toner is larger than the sphere. However, this method cannot show the correct surface property when the particle size shows a broad distribution or a distorted distribution because of the use of the average particle size.

On the other hand, although a toner produced by the emulsion polymerization and aggregation method has a sharp particle size distribution and can include particles having various shapes and surface properties, its shape and surface property have broad distributions, and in some cases, particles having unevenness on the surface due to insufficient fusion are contained. When such particles are contained in the toner, the particles is destroyed in a developing device to form fine particles, which cause fogging and scattering, and thus the high image quality and the high reliability cannot be realized. It has been found that even in the case where fine particles are not formed, fine particles added to the toner for improving the electrophotographic characteristics, such as charging characteristics and transferring characteristics, are buried on the concave parts on the toner surface to fail to exhibit their prescribed performance.

### SUMMARY OF THE INVENTION

The invention is to solve the problems described in the foregoing and to provide a toner for developing a static image having excellent charging characteristics and transferring characteristics with excellent maintenance characteristics thereof, and having a small particle diameter with a sharp particle size distribution. The invention is also to provide a process for producing the toner, a developer for a static image using the toner, and a process for producing a color image having high quality and high reliability.

As a result of earnest investigations for solving the problems made by the inventors, the unevenness on the toner surface is suppressed to the level as lower as that does not cause any problem by using a novel parameter, i.e., a surface property index that is obtained by compensating a measured value of a specific surface area with a calculated value of a specific surface area obtained by calculating taking a particle size distribution into account. Thus, the problems have been solved.

The invention provides a toner for developing a static image including at least a binder resin and a colorant, and an external additive adhered on a toner surface, the toner having an average volume particle diameter D₅₀ of about from 3.0 to 8.0 μm, an average volume particle diameter distribution index GSDv of about 1.26 or less, and a surface property index expressed by the following equations of about 6.0 or less:

(surface property index)=(measured specific surface area)/(calculated specific surface area)

(calculated specific surface area)=6Σ(n×R²)/(ρ×Σ(n×R³))

wherein n represents a number of particles in a channel of a Coulter counter; R represents a channel particle diameter of a Coulter counter; and ρ represents a toner density, provided that measurement of the specific surface area is conducted by an adsorption method.

The external additive has an average primary particle size of about from 5 to 100 nm.

The toner may have a shape factor SF1 obtained by the following equation of about from 100 to 140:

SF1=ML²/A

wherein ML represents a peripheral length, and A represents a projected area.

The toner may contain releasing agent particles.

This invention also provides a process for producing a toner for developing a static image, the process including the steps of: mixing at least one kind of a resin fine particle dispersion and at least one kind of a colorant dispersion; adding an aggregating agent to form aggregated bodies; and then heating to a temperature higher than a glass transition point of the resin fine particles, to fuse the aggregated bodies to form toner particles.

At least one kind of a resin fine particle dispersion may be further added to the aggregated body dispersion; the fine particles are adhered to form adhered particles; and then the dispersion is heated to a temperature higher than a glass transition point of the resin fine particles, to fuse the aggregated bodies to form toner particles.

This invention also provides a developer for a static image including the toner and a carrier.

The developer may be used for such an image forming method comprising a step of forming a static latent image on a static latent image holding member; a step of developing the static latent image with a developer to form a toner image; and a step of transferring the toner image to a transfer body.

### DETAILED DESCRIPTION OF THE INVENTION

The inventors have analyzed in detail the shape distribution of a toner having a broad distribution and have found that there is a relationship between the difference in shape and the particle size distribution, i.e., the smaller the particle size is, the nearer a sphere the shape is, and the larger the particle size is, the nearer an irregular shape the shape is. The irregular shape means unevenness, which has concave parts. When the toner particles is mixed with an external additive, the external additive is buried in the concave parts. This phenomenon has been confirmed with a microscope. Because the external additive exhibits its prescribed performance when it is adhered on the outer surface of the toner particles, the external additive buried in the concave parts not only does not exhibit its inherent function, but also changes the composition of the toner, to impair the initial purpose of the compositional design of the toner.

In the invention, the particle diameter in the channels of the Coulter counter and the number of particles of the particle diameter are measured, to obtain the calculated specific surface area in the sphere conversion of the particles, and the surface property index is obtained by dividing the measured specific surface area by the calculated specific surface area. By using the surface property index, it has been possible to provide a toner in that the influence of the irregular shape of the toner particles in the large particle size side is suppressed, and the function of the external additive is utilized.

That is, the calculated specific surface area in the invention is obtained by the following equation:

(calculated specific surface area)=6Σ(n×R²)/(ρ×Σ(n×R³))

wherein n represents a number of particles in a channel of a Coulter counter; R represents a channel particle diameter of a Coulter counter; and ρ represents a toner density, provided that measurement of the specific surface area is conducted by an adsorption method.

The surface property index is obtained from the measured specific surface area obtained by an adsorption method by the following equation:

(measured specific surface area)/(calculated specific surface area)

In the invention, the surface property index is necessarily about 6.0 or less. When the toner satisfies the condition, burying of the external additive into the concave parts of the toner particles is suppressed, so as to obtain a toner excellent in charging characteristics and transferring characteristics. When it exceeds 6.0, the influence of the unevenness of the toner particles having a larger particle size cannot be ignored, and the function of the external additive, i.e., improvement in charging characteristics and transferring characteristics, cannot be exhibited.

The actual measurement of the specific surface area is measured by using the BET equation with the one-point method of the nitrogen adsorption method using Flowsorp 2300 produced by Shimadzu Corp.

Another characteristic feature of the toner of the invention is that the shape factor SF1 is in the range of about from 100 to 140. More specifically, it is a value obtained by dividing the area of circle (πL²/4) of the maximum diameter L of the toner particles when the particles are projected on a plane, by the projected area A of the particles, which is defined by the following equation:

(ML²/A)=((πL²/4)/A)×100(%)

The measurement of the shape factor is conducted by using a LUZEX image analyzing device.

A toner according to the invention having a shape factor SF1 of about from 100 to 120 has a shape near a sphere, and since an extremely high transferring efficiency is expected, the toner is suitably used as a toner for a cleaner-less developing device. A toner according to the invention having a shape factor SF1 of about from 120 to 140 has a distorted shape and is suitably used as a toner for a developing device having a blade cleaning mechanism.

The toner of the invention has an average volume particle diameter D₅₀ of about from 3.0 to 8.0 μm. When D₅₀ is less than 3.0 μm, it is difficult to handle as a developer, and when it exceeds 8.0 μm, the image quality is liable to be deteriorated. The average volume particle diameter D₅₀ is also called as a volume median diameter, which is measured with a Coulter counter (TAII, produced by Nikkaki Co., Ltd.) in the invention.

The toner of the invention has an average volume particle diameter distribution index GSDv of about 1.26 or less. When GSDv exceeds 1.26, deterioration in image quality occurs. The GSDv is expressed by a square root of a ratio of the volume average particle diameter D₈₄ where the accumulated volume is 84% to the volume average particle diameter D₁₆ where the accumulated volume is 16%, as shown by the following equation:

GSDv=(D₈₄/D₁₆)^{½}

The process for producing the toner of the invention is not particularly limited as far as a toner satisfying the characteristics described in the foregoing can be obtained. However, the emulsion polymerization and aggregation method is preferred from the standpoint of easiness of production. The process for producing the toner of the invention includes the steps of: mixing a dispersion of resin particles obtained by emulsion polymerization and a coloring agent particle dispersion; adding an aggregating agent to form aggregated particles having a diameter that is substantially the same as the particle diameter of the toner; and then heating to a temperature higher than a glass transition point of the resin fine particles, to fuse the aggregated particles to form toner particles. When a releasing agent is added, a releasing agent dispersion may be added when the resin particle dispersion and the colorant particle dispersion are mixed, or a releasing agent particle dispersion or a resin particle dispersion may be added during aggregation. In particular, a method where a resin fine particle dispersion is added to adhere the resin fine particles on the surface of the aggregated particles is preferred since the surface conditions of the toner can be easily controlled.

The resin used in the resin fine particles of the toner of the invention is not particularly limited. Specific examples thereof include a homopolymer including a monomer including a styrene, such as styrene, parachlorostyrene and α-methylstyrene; an acrylic monomer, such as methyl acrylate, ethyl acrylate, n-propyl acrylate, lauryl acrylate and 2-ethylhexyl acrylate; a methacrylic monomer, such as methyl methacrylate, ethyl methacrylate, n-propyl methacrylate, lauryl methacrylate and 2-ethylhexyl methacrylate; an ethylenic unsaturated acid monomer, such as acrylic acid, methacrylic acid and sodium stylenesulfonic acid; a vinylnitrile, such as acrylonitrile and methacrylonitrile; a vinyl ether, such as vinyl methyl ether and vinyl isobutyl ether; a vinyl ketone, such as vinyl methyl ketone, vinyl ethyl ketone and vinyl isopropenyl ketone; and an olefin, such as ethylene, propylene and butadiene; a copolymer combining two or more of these monomers; and a mixture thereof, as well as an epoxy resin, a polyester resin, a polyurethane resin, a polyamide resin, a cellulose resin, a polyether resin, a non-vinyl condensation resin, a mixture of these resin and the vinyl series resins described above, and a graft polymer obtained by polymerizing the vinyl monomer in the presence of these resins.

The resin fine particle dispersion used in the invention can be obtained by an arbitrary method, such as an emulsion polymerization method, or a polymerization method of a non-uniform dispersion system like the emulsion polymerization method. It is also possible that a polymer having been obtained by uniform polymerization by the solution polymerization method or the bulk polymerization method is added to a solvent, in which the polymer is not dissolved, along with a stabilizer, and the polymer is mechanically mixed and dispersed in the solvent.

For example, in the case where a vinyl series monomer is used, a resin fine particle dispersion can be produced by the emulsion polymerization method or the seed polymerization method by using an ionic surface active agent, preferably a combination of an ionic surface active agent and a nonionic surface active agent.

The surface active agent used herein is not particularly limited, and examples thereof include an anionic surface active agent, such as a sulfate series, a sulfonate series, a phosphate series and soap; a cationic surface active agent, such as an amine salt type and a quaternary ammonium salt type; a nonionic surface active agent, such as a polyethylene glycol series, an alkylphenol ethyleneoxide adduct series, an alkylalcohol ethyleneoxide adduct series and a polyvalent alcohol; and various graft polymers.

In the case where the resin fine particle dispersion is produced by the emulsion polymerization method, when a small amount of an unsaturated acid such as acrylic acid, methacrylic acid, maleic acid, and styrenesulfonic acid is added as a part of the monomer components, a protective colloid layer can be formed on the fine particle surfaces, thereby enabling to undergo soap-free polymerization, and hence, such is particularly preferred. Incidentally, even in other polymerization methods than the emulsion polymerization method, there is a premise that the particle size of the rein fine particles is basically thoroughly smaller than the desired particle size at the time of completion of aggregation.

Examples of the releasing agent fine particles used in the invention include a low molecular weight polyolefin, such as polyethylene, polypropylene and polybutene; a silicone; a fatty acid amide, such as oleic acid amide, erucic acid amide, ricinolic acid amide and stearic acid amide; a vegetable wax, such as carnauba wax, rice wax, candelilla wax, Japan wax and jojoba oil; an animal wax, such as bees wax; a mineral or petroleum wax, such as montan wax, ozocerite, ceresine, paraffin wax, microcrystalline wax and Fischer-Tropsch wax; and a modified product thereof.

The dispersion of the wax in the form of a particle having a diameter of 1 μm or less can be prepared in such a manner that the wax is dispersed in water along with a polymer electrolyte, such as an ionic surface active agent, a polymer acid and a polymer base, and then formed into fine particles in a homogenizer or a pressure delivery disperzer applying a strong share stress under heating to a temperature higher than the melting point of the wax. The releasing agent fine particles may be added to the mixed solvent along with the resin fine particle component, or divided and added stepwise.

Examples of the colorant used in the invention include a pigment, such as carbon black, Chrome Yellow, Hansa Yellow, Benzidine Yellow, Indanthrene Yellow, Quinoline Yellow, Permanent Orange GTR, Pyrazolone Orange, Vulcan Orange, Watchung Red, Permanent Red, Brilliant Carmine 3B, Brilliant Carmine 6B, Du Pont Oil Red, Pyrazolone Red, Lithol Red, Rhodamine B Lake, Lake Red C, Rose Bengal, Aniline Blue, Ultramarine Blue, Calco Oil Blue, Methylene Blue Chloride, Phthalocyanine Blue, Phthalocyanine Green and Malachite Green Oxalate; and a dye, such as an acridine series, a xanthene series, an azo series, a benzoquinone series, an azine series, an anthraquinone series, a thioindigo series, a dioxane series, a thiazine series, an azomethine series, an indigo series, a thioindigo series, a phthalocyanine series, an aniline black series, a polymethine series, a triphenylmethane series, a diphenylmethane series, thiadine series, a thiazole series and a xanthene series. These pigments and dyes may be used singly or in combination of two or more of them.

As the dispersing method for the colorant, any method that is generally employed may be used without limitation, and for example, a rotation sharing type homogenizer, and a ball mill, a sand mill and a Dyno-mill having a medium can be used.

The resulting colorant fine particle dispersion may be added to the mixed solvent along with other fine particle components at the same time, or may be divided and added stepwise.

In the case where the toner is used as a magnetic toner, magnetic powder is contained in the toner. Examples of the magnetic powder include ferrite, magnetite, a metal, such as reduced iron, cobalt, nickel and manganese, an alloy, and a compound containing the metal.

Furthermore, depending on necessity, a charge controlling agent that is generally employed, such as a quaternary ammonium salt compound, a Nigrosine series compound and a triphenylmethane series pigment, may be added.

As the aggregating agent used in the invention, a surface active agent having a polarity contrary to the surface active agent used in the resin particle dispersion and the colorant particle dispersion, and an inorganic metallic salt of divalent or more are preferably used. In particular, the use of an inorganic metallic salt is preferred since the used amount of the surface active agent can be decreased, to improve the charging characteristics.

Examples of the inorganic metallic salt include a metallic salt, such as calcium chloride, calcium nitrate, barium chloride, magnesium chloride, zinc chloride, aluminum chloride and aluminum sulfate, and an inorganic metallic salt polymer, such as polyaluminum chloride, polyaluminum hydroxide and calcium polysulfate. Among these, aluminum chloride and its polymer are preferred. In order to obtain a further sharp particle size distribution, a divalent salt is preferred over a monovalent one, a trivalent salt is preferred over a divalent one, a tetravalent salt is preferred over a trivalent one, and when the valence number is the same, an inorganic metallic salt polymer is preferred.

The toner having the characteristic features of the invention can be produced, for example, by the following manner. Upon stabilizing the aggregation particles, the surface property of the toner can be controlled by adjusting the pH, and the shape of the toner particles can be controlled by adjusting the fusing temperature. Thus, the toner having the special characteristics according to the invention can be produced. When a toner is produced according to the related art aggregation and fusing method, because a surface active agent having the same polarity as in the resin particle dispersion is added to stabilize the aggregated particles, the degree of fusion, i.e., the shape of the particles, can be controlled by adjusting the fusing temperature, but the surface property cannot be controlled.

For example, in the case where a resin particle dispersion stabilized with an anionic surface active agent is used, when the pH is high, the surface of the aggregated particles is stabilized, and thus upon fusing the particles by increasing the temperature, particles having unevenness on the surface thereof are obtained. On the other hand, in the case where the particles are fused under a pH as low as possible in that the aggregated particles can be stably maintained, the surface of the particles can be smooth. At this time, when the fusing temperature is maintained at a low temperature, the shape of the particles becomes irregular, and when the fusing temperature is increased, the shape of the particles approaches sphere.

The particles obtained through fusing can be toner particles through a solid-liquid separation step, e.g., filtering, and depending on necessity, a washing step and a drying step. In this case, in order to ensure the charging characteristics and the reliability as sufficient as a toner, it is preferred to sufficiently conduct washing.

Upon drying step, an arbitrary method can be employed, such as a vibration type fluidized drying method, a spray drying method, a freeze drying method and a flash jet method that are generally employed. The toner particles are preferably adjusted to have a water content of about 1.0% or less, and preferably about 0.5% or less, after drying.

The toner of the invention generally has a charge amount of about from 10 to 40 μC/g, and preferably about from 15 to 35 μC/g, as an absolute value. When the charge amount is less than 10 μC/g, adhesion on the background (fogging) is liable to occur, and when it exceeds 40 μC/g, the image density is liable to be decreased. The ratio of the charge amount in the summer period (28° C., 85% RH) to the charge amount in the winter period (10° C., 15% RH), i.e., the environmental dependency index of (high temperature and high humidity charge amount)/(low temperature and low humidity charge amount), of the toner for developing a static image is generally about from 0.2 to 1.3, and preferably about from 0.7 to 1.0. When the ratio is outside the range of about from 0.2 to 1.3, there is a possibility in that the charge stability and the reliability under the fluctuating environmental conditions are deteriorated.

The toner of the invention may be used by mixing with various external additives. As the external additive, inorganic fine particles, such as silica, alumina, titania, calcium carbonate, magnesium carbonate and tricalcium phosphate, and a resin fine particles, such as a vinyl series resin, polyester and silicone, can be used for improving the charge controllability, the fluidity and the cleaning property. The addition of the external additive to the toner is conducted by mixing under the dry condition with the application of a sharing force.

### EXAMPLES

A resin fine particle dispersion, pigment dispersions and a releasing agent particle dispersion are previously prepared by the following manners.

### Preparation of Resin Fine Particle Dispersion (1)

| | | |
|---|---|---|
| Styrene | 328 | parts by weight |
| n-Butyl acrylate | 72 | parts by weight |
| Acrylic acid | 6 | parts by weight |
| Dodecanethiol | 6 | parts by weight |
| Carbon tetrabromide | 4 | parts by weight |

416 g of a solution obtained by mixing the foregoing components, 6 g of a nonionic surface active agent (Nonipol 400, produced by Sanyo Chemical Industries, Ltd.) and 10 g of an anionic surface active agent (Neogen R, produced by Daiichi Kogyo Seiyaku Co., Ltd.) are dissolved in 550 g of ion exchanged water, and the solution is dispersed and emulsified in a flask. While slowly stirring and mixing, 50 g of ion exchanged water containing 4 g of ammonium persulfate is added over 10 minutes. Thereafter, after thoroughly replacing the flask with nitrogen, the flask is placed over an oil bath under stirring, and heated until the temperature of the reaction system reaches 70° C., followed by conducting the polymerization for 5 hours at that temperature.

The resulting latex has a volume average particle size (D₅₀) of the resin fine particles of 180 nm measured by a laser diffraction particle size distribution measurement apparatus (LA-700, produced by Horiba, Ltd.), a glass transition point of the resin of 58° C. measured by a differential scanning calorimeter (DSC-50, produced by Shimadzu Corp.) under the condition in that the temperature increasing rate is 10° C./min, and a weight average molecular weight (polystyrene conversion) of 33,000 measured by a molecular weight measuring apparatus (HLC-8020, produced by Tosoh Corp.) using THF as a solvent.

### Preparation of Releasing Agent Fine Particle Dispersion (1)

| | | |
|---|---|---|
| Paraffin wax | 50 | parts by weight |
| (HNP0190, produced by Nippon Seiro Co., | | |
| Ltd., melting point: 85° C.) | | |
| Anionic surface active agent | 3 | parts by weight |
| (Neogen R, produced by Daiichi | | |
| Kogyo Seiyaku Co., Ltd.) | | |
| Ion exchanged water | 150 | parts by weight |

The foregoing components are sufficiently dispersed by heating to 95° C. with a homogenizer (Ultra-Turrax T50, produced by IKA Works Inc.), and then subjected to a dispersion treatment in a pressure delivery homogenizer to prepare a releasing agent dispersion having a volume average particle diameter (D₅₀) of the releasing agent fine particles of 200 nm.

### Preparation of Pigment Dispersion (1)

| | | |
|---|---|---|
| Carbon black | 50 | parts by weight |
| (Mogul L, produced by Cabot Corp.) | | |
| Anionic surface active agent | 6 | parts by weight |
| (Neogen R, produced by Daiichi Kogyo | | |
| Seiyaku Co., Ltd.) | | |
| Ion exchanged water | 200 | parts by weight |

The foregoing components are dispersed in an ultrasonic dispersing apparatus (W-113, produced by Honda Electronics Co., Ltd.) for 20 minutes, and thus a carbon black dispersion having a volume average particle size (D₅₀) of 200 nm.

### Preparation of Pigment Dispersion (2)

| | | |
|---|---|---|
| Copper phthalocyanine pigment | 50 | parts by weight |
| (produced by BASF Corp.) | | |
| Anionic surface active agent | 8 | parts by weight |
| (Neogen R, produced by Daiichi Kogyo | | |
| Seiyaku Co., Ltd.) | | |
| Ion exchanged water | 150 | parts by weight |

The foregoing components are dispersed in the foregoing ultrasonic dispersing apparatus for 20 minutes, and thus a blue pigment dispersion having a volume average particle size (D₅₀) of 180 nm.

### Preparation of Pigment Dispersion (3)

| | | |
|---|---|---|
| Yellow pigment | 50 | parts by weight |
| (Pigment Yellow 180, produced | | |
| by Hoechst AG) | | |
| Anionic surface active agent | 8 | parts by weight |
| (Neogen R, produced by Daiichi Kogyo | | |
| Seiyaku Co., Ltd.) | | |
| Ion exchanged water | 200 | parts by weight |

The foregoing components are dispersed in a homogenizer (Ultra-Turrax T50, produced by IKA Works Inc.) for 10 minutes and further dispersed in the foregoing dispersing apparatus for 30 minutes, and thus a yellow pigment dispersion having a volume average particle size (D₅₀) of 250 nm.

### Preparation of Pigment Dispersion (4)

| | | |
|---|---|---|
| Red pigment | 50 | parts by weight |
| (Pigment Red 122, produced by | | |
| Dainichiseika Color and Chemicals | | |
| Mfg. Co., Ltd.) | | |
| Anionic surface active agent | 8 | parts by weight |
| (Neogen R, produced by Daiichi Kogyo | | |
| Seiyaku Co., Ltd.) | | |
| Ion exchanged water | 200 | parts by weight |

The foregoing components are dispersed in a homogenizer (Ultra-Turrax T50, produced by IKA Works Inc.) for 10 minutes, and thus a red pigment dispersion having a volume average particle size (D₅₀) of 250 nm.

### Example 1

### Preparation of Aggregated Particle Dispersion

| | | |
|---|---|---|
| Resin fine particle dispersion (1) | 260 | parts by weight |
| Releasing agent dispersion (1) | 40 | parts by weight |
| Pigment dispersion (1) | 30 | parts by weight |
| Aluminum polychloride | 3 | parts by weight |

The foregoing components are placed in a stainless steel round flask, and thoroughly mixed and dispersed by a homogenizer (Ultra-Turrax T50, produced by IKA Works Inc.). The flask is heated over an oil bath for heating to 50° C. under stirring, and after maintaining 30 minutes at that temperature, the temperature of the oil bath is increased to 52° C., followed by maintaining that temperature, to obtain an aggregated particle dispersion. As a result of measurement by a Coulter counter (TAII, produced by Nikkaki Co., Ltd.), the aggregated particles in the dispersion have a volume average particle size (D₅₀) of 5.7 μm and a volume average particle size distribution (GSDv) of 1.24.

### Adhesion of Resin Fine Particles

70 parts by weight of the resin fine particle dispersion (1) is gradually added to 333 parts by weight of the aggregated particle dispersion, and the mixture is heated under stirring for 30 minutes to adhere the resin fine particles on the surface of the aggregated particles. As a result of measurement, the particles have a particle size of 6.0 μm and GSDv of 1.23.

### Coalescence of Aggregated Particles

A sodium hydroxide aqueous solution is added to the aggregated particle dispersion to the pH being 10.0, and then heated to 90° C. Thereafter, a diluted nitric acid aqueous solution is added to the aggregated particle dispersion to decrease the pH to 5, followed by maintaining for 3 hours, to obtain coalesced particles. As a result of measurement by a Coulter counter, the fused particles have a volume average particle size (D₅₀) of 6.1 μm and a volume average particle size distribution (GSDv) of 1.23. The measurement by a Luzex image analyzing device (LUZEX III, produced by Nireco Co., Ltd.) reveals that the shape factor SF1 (ML²/A) of the particles is 134. The measurement by a specific surface area measuring device (Flowsorp 2300, produced by Shimadzu Corp.) using the BET equation with the one-point method of the nitrogen adsorption method reveals that the specific surface area of the particles is 5.4. The calculated specific surface area of the particles obtained from the count numbers of the particles for the respective channels of the Coulter counter is 0.951, and therefore the surface property index is 5.7.

The toner particles without adding an external additive are allowed to stand in a high temperature and high humidity environment (28° C., 85% RH) and a low temperature and low humidity environment (10° C., 30% RH) for 12 hours, and measured for the charge amount (μC/g). The charge amount (Q/M) in the high temperature and high humidity environment is −18 μC/g, and that in the low temperature and low humidity environment is −24 μC/g, i.e., the charging characteristics are good.

0.43 g of hydrophobic silica (TS720, produced by Cabot Corp., average primary particle size: 12 nm) is added to 100 g of the toner particles, and mixed by a sample mill. The resulting externally added toner is weighed to be a toner concentration of 5% by weight for a ferrite carrier having an average particle size of 50 μm coated with polymethacrylate (produced by Soken Kagaku Co., Ltd.) in an amount of 1% by weight, and they are stirred and mixed in a ball mill for 5 minutes to prepare a developer. The observation by a scanning electron microscope (SEM) reveals that the external additive is uniformly adhered on the toner surface.

The developer is subjected to a duplicating test of 10,000 sheets under a high temperature and high humidity environment (28° C., 85% RH) and a low temperature and low humidity environment (10° C., 30% RH) using a modified duplicator V500 produced by Fuji Xerox Co., Ltd., to evaluate the image quality. As a result, formation of fog and scattering of the toner are substantially not observed in both the environments, and good image quality is confirmed. The toner remaining on a photoreceptor drum is transferred to a tape and subjected to a sensory test, and good transferring characteristics are confirmed.

### Example 2

| | | |
|---|---|---|
| Resin fine particle dispersion (1) | 258 | parts by weight |
| Releasing agent dispersion (1) | 40 | parts by weight |
| Pigment dispersion (2) | 36 | parts by weight |
| Aluminum polychloride | 3 | parts by weight |

An aggregated particle dispersion is prepared by using the foregoing components in the same manner as in Example 1, and the resin fine particle dispersion (1) is similarly added to adhere the resin fine particles on the surface of the aggregated particles, so as to obtain a dispersion of aggregated particles having a volume average particle size (D₅₀) of 5.6 μm and a volume average particle size distribution (GSDv) of 1.23. An sodium hydroxide aqueous solution is added to the dispersion to adjust the pH at 52° C. to 10, and after stabilizing the aggregated particles, the aggregated particles are fused under the same conditions as in Example 1, to obtain fused particles. The fused particles have a volume average particle size (D₅₀) of 5.6 μm, a volume average particle size distribution (GSDv) of 1.24, and a shape factor SF1 of 132. The measurement of the specific surface area in the same manner as in Example 1 reveals that the specific surface area is 5.9. The calculation of the specific surface area by using the count numbers of the particles in the respective channels of the Coulter counter reveals that the calculated specific surface area is 1.031, and the surface property index obtained is 5.7.

The toner particles without adding an external additive are allowed to stand in a high temperature and high humidity environment (28° C., 85% RH) and a low temperature and low humidity environment (10° C., 30% RH) for 12 hours, and measured for the charge amount (μC/g). The charge amount (Q/M) in the high temperature and high humidity environment is −24 μC/g, and the charge amount in the low temperature and low humidity environment is −30 μC/g, i.e., the charging characteristics are good.

The hydrophobic silica is added to the toner particles in the same manner as in Example 1, and a developer is prepared by using the same coated carrier. The observation by a scanning electron microscope (SEM) reveals that the external additive is uniformly adhered on the toner surface.

The developer is subjected to a duplicating test of 10,000 sheets under a high temperature and high humidity environment (28° C., 85% RH) and a low temperature and low humidity environment (10° C., 30% RH) using a modified duplicator V500 produced by Fuji Xerox Co., Ltd., to evaluate the image quality. As a result, formation of fog and scattering of the toner are substantially not observed in both the environments, and good image quality is confirmed. The toner remaining on a photoreceptor drum is transferred to a tape and subjected to a sensory test, and good transferring characteristics are confirmed.

### Example 3

| | | |
|---|---|---|
| Resin fine particle dispersion (1) | 254 | parts by weight |
| Releasing agent dispersion (1) | 40 | parts by weight |
| Pigment dispersion (3) | 53 | parts by weight |
| Aluminum polychloride | 3 | parts by weight |

An aggregated particle dispersion is prepared by using the foregoing components in the same manner as in Example 1, and the resin fine particle dispersion (1) is similarly added to adhere the resin fine particles on the surface of the aggregated particles, so as to obtain a dispersion of aggregated particles having a volume average particle size (D₅₀) of 4.7 μm and a volume average particle size distribution (GSDv) of 1.23. A sodium hydroxide aqueous solution is added to the dispersion to adjust the pH at 52° C. to 10. After stabilizing the aggregated particles, the dispersion is heated to 97° C., and a diluted nitric acid aqueous solution is added to decrease the pH to 5, followed by maintaining for 5 hours, to obtain fused particles. The fused particles have a volume average particle size (D₅₀) of 4.8 μm, a volume average particle size distribution (GSDv) of 1.24, and a shape factor SF1 of 128. The measurement of the specific surface area in the same manner as in Example 1 reveals that the specific surface area is 4.4. The calculation of the specific surface area by using the count numbers of the particles in the respective channels of the Coulter counter reveals that the calculated specific surface area is 1.207, and the surface property index obtained is 3.7.

The toner particles without adding an external additive are allowed to stand in a high temperature and high humidity environment (28° C., 85% RH) and a low temperature and low humidity environment (10° C., 30% RH) for 12 hours, and measured for the charge amount (μC/g). The charge amount (Q/M) in the high temperature and high humidity environment is −18 μC/g, and the charge amount in the low temperature and low humidity environment is −26 μC/g, i.e., the charging characteristics are good.

The hydrophobic silica is added to the toner particles in the same manner as in Example 1, and a developer is prepared by using the same coated carrier. The observation by a scanning electron microscope (SEM) reveals that the external additive is uniformly adhered on the toner surface.

The developer is subjected to a duplicating test of 10,000 sheets under a high temperature and high humidity environment (28° C., 85% RH) and a low temperature and low humidity environment (10° C., 30% RH) using a modified duplicator V500 produced by Fuji Xerox Co., Ltd., to evaluate the image quality. As a result, formation of fog and scattering of the toner are substantially not observed in both the environments, and good image quality is confirmed. The toner remaining on a photoreceptor drum is transferred to a tape and subjected to a sensory test, and good transferring characteristics are confirmed.

### Example 4

| | | |
|---|---|---|
| Resin fine particle dispersion (1) | 250 | parts by weight |
| Releasing agent dispersion (1) | 40 | parts by weight |
| Pigment dispersion (4) | 60 | parts by weight |
| Aluminum polychloride | 3 | parts by weight |

An aggregated particle dispersion is prepared by using the foregoing components in the same manner as in Example 1, and the resin fine particle dispersion (1) is similarly added to adhere the resin fine particles on the surface of the aggregated particles, so as to obtain a dispersion of aggregated particles having a volume average particle size (D₅₀) of 5.8 μm and a volume average particle size distribution (GSDv) of 1.19. A sodium hydroxide aqueous solution is added to the dispersion to adjust the pH at 52° C. to 10. After stabilizing the aggregated particles, the dispersion is heated to 97° C., and a diluted nitric acid aqueous solution is added to decrease the pH to 5, followed by maintaining for 10 hours, to obtain fused particles. The fused particles have a volume average particle size (D₅₀) of 6.0 μm, a volume average particle size distribution (GSDv) of 1.19, and a shape factor SF1 of 120. The measurement of the specific surface area in the same manner as in Example 1 reveals that the specific surface area is 1.5. The calculation of the specific surface area by using the count numbers of the particles in the respective channels of the Coulter counter reveals that the calculated specific surface area is 0.951, and the surface property index obtained is 1.6.

The toner particles without adding an external additive are allowed to stand in a high temperature and high humidity environment (28° C., 85% RH) and a low temperature and low humidity environment (10° C., 30% RH) for 12 hours, and measured for the charge amount (μC/g). The charge amount (Q/M) in the high temperature and high humidity environment is −20 μC/g, and the charge amount in the low temperature and low humidity environment is −28 μC/g, i.e., the charging characteristics are good.

The hydrophobic silica is added to the toner particles in the same manner as in Example 1, and a developer is prepared by using the same coated carrier. The observation by a scanning electron microscope (SEM) reveals that the external additive is uniformly adhered on the toner surface.

The developer is subjected to a duplicating test of 10,000 sheets under a high temperature and high humidity environment (28° C., 85% RH) and a low temperature and low humidity environment (10° C., 30% RH) using a modified duplicator V500 produced by Fuji Xerox Co., Ltd., to evaluate the image quality. As a result, formation of fog and scattering of the toner are substantially not observed in both the environments, and good image quality is confirmed. The toner remaining on a photoreceptor drum is transferred to a tape and subjected to a sensory test, and good transferring characteristics are confirmed.

### Comparative Example 1

| | |
|---|---|
| Resin fine particle dispersion (1) | 258 parts by weight |
| Releasing agent dispersion (1) | 40 parts by weight |
| Pigment dispersion (2) | 36 parts by weight |
| Aluminum polychloride | 3 parts by weight |

An aggregated particle dispersion is prepared by using the foregoing components in the same manner as in Example 1, and the resin fine particle dispersion (1) is similarly added to adhere the resin fine particles on the surface of the aggregated particles, so as to obtain a dispersion of aggregated particles having a volume average particle size (D₅₀) of 5.1 μm and a volume average particle size distribution (GSDv) of 1.22. A sodium hydroxide aqueous solution is added to the dispersion to adjust the pH at 52° C. to 10. After stabilizing the aggregated particles, the dispersion is heated to 97° C., followed by maintaining for 5 hours, to obtain fused particles. The fused particles have a volume average particle size (D₅₀) of 5.1 μm, a volume average particle size distribution (GSDv) of 1.22, and a shape factor SF1 of 135. The measurement of the specific surface area in the same manner as in Example 1 reveals that the specific surface area is 7.6. The calculation of the specific surface area by using the count numbers of the particles in the respective channels of the Coulter counter reveals that the calculated specific surface area is 1.140, and the surface property index obtained is 6.6.

The toner particles without adding an external additive are allowed to stand in a high temperature and high humidity environment (28° C., 85% RH) and a low temperature and low humidity environment (10° C., 30% RH) for 12 hours, and measured for the charge amount (μC/g). The charge amount (Q/M) in the high temperature and high humidity environment is −16 μC/g, and the charge amount in the low temperature and low humidity environment is −24 μC/g, i.e., slightly low charging characteristics are shown in the high temperature and high humidity environment.

The hydrophobic silica is added to the toner particles in the same manner as in Example 1, and a developer is prepared by using the same coated carrier. The observation by a scanning electron microscope (SEM) reveals that the external additive is adhered as locally distributed in the concave parts on the toner surface.

The developer is subjected to a duplicating test of 10,000 sheets under a high temperature and high humidity environment (28° C., 85% RH) and a low temperature and low humidity environment (10° C., 30% RH) using a modified duplicator V500 produced by Fuji Xerox Co., Ltd., to evaluate the image quality. As a result, formation of fog and scattering of the toner are observed in both the environments, and the image quality is deteriorated. The toner remaining on a photoreceptor drum is transferred to a tape and subjected to a sensory test, and it is confirmed that a large proportion of the toner remains but is not transferred to paper, i.e., transfer failure is observed.

### Comparative Example 2

| | |
|---|---|
| Resin fine particle dispersion (1) | 254 parts by weight |
| Releasing agent dispersion (1) | 40 parts by weight |
| Pigment dispersion (3) | 53 parts by weight |
| Aluminum polychloride | 3 parts by weight |

An aggregated particle dispersion is prepared by using the foregoing components in the same manner as in Example 1, and the resin fine particle dispersion (1) is similarly added to adhere the resin fine particles on the surface of the aggregated particles, so as to obtain a dispersion of aggregated particles having a volume average particle size (D₅₀) of 5.7 μm and a volume average particle size distribution (GSDv) of 1.24. A sodium hydroxide aqueous solution is added to the dispersion to adjust the pH at 52° C. to 10. After stabilizing the aggregated particles, the dispersion is heated to 97° C., followed by maintaining for 3 hours, to obtain fused particles. The fused particles have a volume average particle size (D₅₀) of 5.8 μm, a volume average particle size distribution (GSDv) of 1.24, and a shape factor SF1 of 137. The measurement of the specific surface area in the same manner as in Example 1 reveals that the specific surface area is 6.4. The calculation of the specific surface area by using the count numbers of the particles in the respective channels of the Coulter counter reveals that the calculated specific surface area is 1.001, and the surface property index obtained is 6.4.

The toner particles without adding an external additive are allowed to stand in a high temperature and high humidity environment (28° C., 85% RH) and a low temperature and low humidity environment (10° C., 30% RH) for 12 hours, and measured for the charge amount (μC/g). The charge amount (Q/M) in the high temperature and high humidity environment is −14 μC/g, and the charge amount in the low temperature and low humidity environment is −20 μC/g, i.e., slightly low charging characteristics are shown in the high temperature and high humidity environment.

The hydrophobic silica is added to the toner particles in the same manner as in Example 1, and a developer is prepared by using the same coated carrier. The observation by a scanning electron microscope (SEM) reveals that the external additive is adhered as locally distributed in the concave parts on the toner surface.

The developer is subjected to a duplicating test of 10,000 sheets under a high temperature and high humidity environment (28° C., 85% RH) and a low temperature and low humidity environment (10° C., 30% RH) using a modified duplicator V500 produced by Fuji Xerox Co., Ltd., to evaluate the image quality. As a result, formation of fog and scattering of the toner are observed in both the environments, and the image quality is deteriorated. The toner remaining on a photoreceptor drum is transferred to a tape and subjected to a sensory test, and it is confirmed that a large proportion of the toner remains but is not transferred to paper, i.e., transfer failure is observed.

### Comparative Example 3

| | |
|---|---|
| Resin fine particle dispersion (1) | 250 parts by weight |
| Releasing agent dispersion (1) | 40 parts by weight |
| Pigment dispersion (4) | 60 parts by weight |
| Aluminum polychloride | 3 parts by weight |

An aggregated particle dispersion is prepared by using the foregoing components in the same manner as in Example 1, and the resin fine particle dispersion (1) is similarly added to adhere the resin fine particles on the surface of the aggregated particles, so as to obtain a dispersion of aggregated particles having a volume average particle size (D₅₀) of 6.1 μm and a volume average particle size distribution (GSDv) of 1.23. A sodium hydroxide aqueous solution is added to the dispersion to adjust the pH at 52° C. to 10. After stabilizing the aggregated particles, the dispersion is heated to 97° C., followed by maintaining for 10 hours, to obtain fused particles. The fused particles have a volume average particle size (D₅₀) of 6.2 μm, a volume average particle size distribution (GSDv) of 1.23, and a shape factor SF1 of 128. The measurement of the specific surface area in the same manner as in Example 1 reveals that the specific surface area is 9.8. The calculation of the specific surface area by using the count numbers of the particles in the respective channels of the Coulter counter reveals that the calculated specific surface area is 0.929, and the surface property index obtained is 10.5.

The toner particles without adding an external additive are allowed to stand in a high temperature and high humidity environment (28° C., 85% RH) and a low temperature and low humidity environment (10° C., 30% RH) for 12 hours, and measured for the charge amount (μC/g). The charge amount (Q/M) in the high temperature and high humidity environment is −10 μC/g, and the charge amount in the low temperature and low humidity environment is −15 μC/g, i.e., slightly low charging characteristics are shown in both the environments.

The hydrophobic silica is added to the toner particles in the same manner as in Example 1, and a developer is prepared by using the same coated carrier. The observation by a scanning electron microscope (SEM) reveals that the external additive is adhered as locally distributed in the concave parts on the toner surface.

The developer is subjected to a duplicating test of 10,000 sheets under a high temperature and high humidity environment (28° C., 85% RH) and a low temperature and low humidity environment (10° C., 30% RH) using a modified duplicator V500 produced by Fuji Xerox Co., Ltd., to evaluate the image quality. As a result, formation of fog and scattering of the toner are observed in both the environments, and the image quality is deteriorated. The toner remaining on a photoreceptor drum is transferred to a tape and subjected to a sensory test, and it is confirmed that a large proportion of the toner remains but is not transferred to paper, i.e., transfer failure is observed.

### Comparative Example 4

| | |
|---|---|
| Resin fine particle dispersion (1) | 260 parts by weight |
| Releasing agent dispersion (1) | 40 parts by weight |
| Pigment dispersion (1) | 30 parts by weight |
| Aluminum polychioride | 3 parts by weight |

An aggregated particle dispersion is prepared by using the foregoing components in the same manner as in Example 1, and the temperature of the oil bath is increased to 57° C., followed by maintaining that temperature, to prepare an aggregated particle dispersion. The resin fine particle dispersion (1) is similarly added to the dispersion to adhere the resin fine particles on the surface of the aggregated particles, so as to obtain a dispersion of aggregated particles having a volume average particle size (D₅₀) of 9.5 μm and a volume average particle size distribution (GSDv) of 1.31. A sodium hydroxide aqueous solution is added to the dispersion to adjust the pH at 52° C. to 10. After stabilizing the aggregated particles, the dispersion is heated to 90° C., and a diluted nitric acid aqueous solution is added to the aggregated particle dispersion to decrease the pH to 5, followed by maintaining for 5 hours, to obtain fused particles. The fused particles have a volume average particle size (D₅₀) of 9.5 μm, a volume average particle size distribution (GSDv) of 1.31, and a shape factor SF1 of 130. The measurement of the specific surface area in the same manner as in Example 1 reveals that the specific surface area is 2.64. The calculation of the specific surface area by using the count numbers of the particles in the respective channels of the Coulter counter reveals that the calculated specific surface area is 0.610, and the surface property index obtained is 4.32.

The toner particles without adding an external additive are allowed to stand in a high temperature and high humidity environment (28° C., 85% RH) and a low temperature and low humidity environment (10° C., 30% RH) for 12 hours, and measured for the charge amount (μC/g). The charge amount (Q/M) in the high temperature and high humidity environment is −28 μC/g, and the charge amount in the low temperature and low humidity environment is −36 μC/g, i.e., the charging characteristics are good.

The hydrophobic silica is added to the toner particles in the same manner as in Example 1, and a developer is prepared by using the same coated carrier. The observation by a scanning electron microscope (SEM) reveals that the external additive is uniformly adhered on the toner surface.

The developer is subjected to a duplicating test of 10,000 sheets under a high temperature and high humidity environment (28° C., 85% RH) and a low temperature and low humidity environment (10° C., 30% RH) using a modified duplicator V500 produced by Fuji Xerox Co., Ltd., to evaluate the image quality. As a result, formation of fog and scattering of the toner are substantially not observed in both the environments, and good image quality is confirmed. The toner remaining on a photoreceptor drum is transferred to a tape and subjected to a sensory test, and good transferring characteristics are confirmed. However, with respect to the image quality, roughness is observed, which is expected to be ascribed to the increase in volume average particle size and particle size distribution, and thus deterioration of the image quality is observed.

The results of the Examples and Comparative Examples are summarized in Table below.

TABLE

| | Ex. 1 | Ex. 2 | Ex. 3 | Ex. 4 | C. Ex. 1 | C. Ex. 2 | C. Ex. 3 | C. Ex. 4 |
|---|---|---|---|---|---|---|---|---|
| Volume average particle size D₅₀ | 6.1 | 5.6 | 4.8 | 6.0 | 5.1 | 5.8 | 6.2 | 9.5 |
| (μm) | | | | | | | | |
| Volume average particle size | 1.23 | 1.24 | 1.24 | 1.19 | 1.22 | 1.24 | 1.23 | 1.31 |
| distribution index GSDv | | | | | | | | |
| Shape factor SF1 | 134 | 132 | 128 | 120 | 135 | 137 | 128 | 130 |
| Measured specific surface area | 5.4 | 5.9 | 4.4 | 1.5 | 7.6 | 6.4 | 9.8 | 2.64 |
| Calculated specific surface area | 0.951 | 1.031 | 1.207 | 0.951 | 1.140 | 1.001 | 0.929 | 0.610 |
| Surface property index | 5.7 | 5.7 | 3.7 | 1.6 | 6.6 | 6.4 | 10.5 | 4.32 |
| Adhesion of external additive to | uniform | uniform | uniform | uniform | locally | locally | locally | uniform |
| toner | adhesion | adhesion | adhesion | adhesion | distributed | distributed | distributed | adhesion |
| Under high temperature | | | | | | | | |
| and high humidity | | | | | | | | |
| Charge amount (μC/g) | −18 | −24 | −18 | −20 | −16 | −14 | −10 | −28 |
| Fog and scattering of toner | none | none | none | none | occurred | occurred | occurred | none |
| Transferring property | good | good | good | good | poor | poor | poor | good |
| Image quality | good | good | good | good | poor | poor | poor | poor |
| Under low temperature and | | | | | | | | |
| low humidity | | | | | | | | |
| Charge amount (μC/g) | −24 | −30 | −26 | −28 | −24 | −20 | −15 | −36 |
| Fog and scattering of toner | none | none | none | none | occurred | occurred | occurred | none |
| Transferring property | good | good | good | good | poor | poor | poor | good |
| Image quality | good | good | good | good | poor | poor | poor | poor |

In the invention, by employing the constitution described in the foregoing, an external additive is not buried in the concave parts on the surface of the toner particles, and a toner for developing a static image that is excellent charging property and transferring property with excellent maintenance property thereof can be provided, so as to be capable of producing a color image with high image quality and high reliability.

What is claimed is:

1. A toner for developing a static image comprising at least a binder resin and a colorant and an external additive, wherein the toner having an average volume particle diameter D₅₀ of about from 3.0 to 8.0 μm, an average volume particle diameter distribution index GSDv of about 1.26 or less, and a surface property index expressed by the following equations of about 6.0 or less:
(surface property index)=(measured specific surface area)/(calculated specific surface area)
(calculated specific surface area)=6Σ(n×R²)/(ρ×Σ(n×R³))
wherein n represents a number of particles in a channel of a Coulter counter; R represents a channel particle diameter of a Coulter counter; and ρ represents a toner density, provided that measurement of the measured specific surface area is conducted by an adsorption method.

2. A toner for developing a static image as claimed in claim 1, wherein the external additive having an average primary particle size of about from 5 to 100 μm.

3. A toner for developing a static image as claimed in claim 1, wherein the toner has a shape factor SF1 obtained by the following equation of about from 100 to 140:
SF1=ML²/A
wherein ML represents a peripheral length, and A represents a projected area.

4. A toner for developing a static image as claimed in claim 1, wherein the toner contains releasing agent particles.

5. A toner for developing a static image as claimed in claim 1, wherein the toner has an absolute value of a charge amount of about from 10 to 40 μC/g.

6. A toner for developing a static image as claimed in claim 1, wherein the toner has an environmental dependency index of (high temperature and high humidity charge amount)/(low temperature and low humidity charge amount) of about from 0.2 to 1.3.

7. A process for producing a toner for developing a static image, the process comprising the steps of: mixing at least one kind of a resin fine particle dispersion and at least one kind of a colorant dispersion; adding an aggregating agent to form aggregated bodies; and then heating to a temperature higher than a glass transition point of the resin fine particles, to fuse the aggregated bodies to form the toner particles as claimed in claim 1.

8. A process for producing a toner for developing a static image as claimed in claim 7, wherein at least one kind of a resin fine particle dispersion is further added to the aggregated body dispersion; the fine particles are adhered to form adhered particles; and then the dispersion is heated to a temperature higher than a glass transition point of the resin fine particles, to fuse the aggregated bodies to form toner particles.

9. A developer for a static image comprising a toner and a carrier, wherein the toner is a toner for developing a static image as claimed in claim 1.

10. A developer for a static image as claimed in claim 9, wherein the carrier has a resin coating layer.

11. An image forming method comprising a step of forming a static latent image on a static latent image holding member; a step of developing the static latent image with a developer to form a toner image; and a step of transferring the toner image to a transfer medium, wherein the developer is a developer as claimed in claim 9.
